(19) United States
(12) Patent Application Publication
(10) Pub. No.: US 2024/0282501 A1
(43) Pub. Date: Aug. 22, 2024

(54) INTEGRATED COUPLED INDUCTOR BASED ON COMPOSITE MATERIAL AND MULTI-PHASE VRM APPLYING THE SAME

(71) Applicant: SHANGHAI METAPWR ELECTRONICS CO. , LTD, Shanghai (CN)

(72) Inventors: Mingzhun ZHANG, Shanghai (CN); Qingdong CHEN, Shanghai (CN); Yayu LI, Shanghai (CN)

(73) Assignee: SHANGHAI METAPWR ELECTRONICS CO. , LTD, Shanghai (CN)

(21) Appl. No.: 18/415,675

(22) Filed: Jan. 18, 2024

(30) Foreign Application Priority Data
Feb. 19, 2023 (CN) 202310135410.6

(51) Int. Cl. H01F 27/24; H01F 27/29; H01F 27/30; H02M 3/00

(52) U.S. Cl. CPC H01F 27/24; H01F 27/292; H01F 27/306; H02M 3/003

(57) ABSTRACT

An integrated coupled inductor based on a composite material and a multi-phase VRM applying the integrated coupled inductor are provided. The integrated coupled inductor comprises an inductor assembly and a connector, wherein the inductor assembly comprises a magnetically permeable core and at least two windings; the magnetically permeable core comprises a first magnetically permeable core and a second magnetically permeable core; the first magnetically permeable core is made of a first magnetic material; the second magnetically permeable core is made of a second magnetic material; and the permeability of the second magnetic material is lower than that of the first magnetic material.

### CROSS-REFERENCE TO RELATED APPLICATION

This application claims the priority benefit of China application serial no. 202310135410.6 filed on Feb. 19, 2023. The entirety of the above-mentioned patent application is hereby incorporated by reference herein and made a part of this specification.

### BACKGROUND

### Technical Field

The invention relates to a high-frequency power supply, in particular to an integrated coupled inductor based on composite material and a multi-phase VRM applying the same.

### Description of Related Art

In recent years, with the development of technologies such as data centers, artificial intelligence and supercomputers, more and more functions powerful ASIC are applied, such as a CPU, a GPU, a machine learning accelerator, a network switch, a server and the like, they consume lot of electricity, for example, thousands of amps are achieved, and their electric power demand fluctuates rapidly. The load is traditionally supplied using a multi-phase voltage regulator module (VRM, Voltage Regulator Modules). In order to keep up with the increase in load current and bandwidth, the phase number of the VRM and the capacitance of the output decoupling capacitor of the VRM are increased, and the method improves the transient response of the traditional VRM to a certain extent.

However, due to the factors such as the larger output impedance of the traditional VRM, the space occupied by the decoupling capacitor and the distance between the decoupling capacitor and the load, the performance limit is achieved in the aspect of transient response. Other techniques to improve traditional VRM, such as increasing switching frequency and/or reducing inductance values, improving transient response, but at the expense of efficiency reduction. The anti-coupled technology has relatively lower leakage inductance, so that the anti-coupled inductor has relatively faster transient response; meanwhile, the anti-coupled inductor has a higher steady-state equivalent inductance, which is beneficial to improve efficiency; i.e., the anti-coupled technology can both meet the requirement for transient performance and also allow for increase in efficiency, so that the anti-coupled technology is a hot spot designed by a VRM. However, with advances in semiconductor technology and increasing current ratings of switching devices, in order to meet demands of increasing power densities of VRM, volume of inductor in VRM needs to be further reduced with increasing power density, i.e. The challenges are small volume, large steady state inductance, small dynamic inductance, high saturation current and low losses.

The coupled inductor in the prior art mainly applies a ferrite material with high permeability, which have good coupled characteristic, low loss, low cost, but low saturation magnetic flux density, which cannot meet the inductance requirements of the VRM inductor under the large direct current bias, and under the condition that the two phases are unbalanced, the magnetically permeable core is easy to saturate, so that the switching device is directly connected, and make the VRM failure. In the prior art, a low-permeability powder core material is also used for manufacturing a coupled inductor, which have good saturation characteristic of the material, high cost, low permeability, and poor coupled characteristic; and along with the improvement of the frequency, the loss of the powder core material is rapidly increased, and the characteristics of the coupled inductor cannot be fully exerted.

### SUMMARY

In general, one aspect features an integrated coupled inductor based on the composite material comprising:
an inductor assembly and a connector;
wherein the inductor assembly comprises a magnetically permeable core and at least two windings;
wherein the magnetically permeable core comprises a first magnetically permeable core and a second magnetically permeable core;
wherein the first magnetically permeable core comprises at least two magnetic columns and at least two cover plates, and the at least two magnetic columns are arranged between the at least two cover plates;
wherein the first magnetically permeable core is made of a first magnetic material;
wherein the second magnetically permeable core is arranged between two adjacent magnetic columns or on the side surface of the first magnetically permeable core;
wherein the second magnetically permeable core is made of a second magnetic material;
wherein the permeability of the second magnetic material is lower than that of the first magnetic material;
wherein each winding is wound on at least one magnetic column corresponding to the winding;
wherein the winding comprises a first bonding pad and a second bonding pad, the first bonding pad is arranged on the top surface of the inductor assembly, and the second bonding pad is arranged on the bottom surface of the inductor assembly;
wherein the connector comprises a power connector and a signal connector; the power connector and the signal connector are arranged on the outer side surface of the inductor assembly respectively;
wherein the power connector is used for transmitting power current between the top surface and the bottom surface of the inductor assembly; the power connector comprises a power Vin and a power GND;
wherein the signal connector is used for transmitting a signal current between the top surface and the bottom surface of the inductor assembly.

Optionally, in the working process of the integrated coupled inductor, the magnetic fluxes generated by the current in the windings are mutually counteracted in the first magnetically permeable core; and the magnetic fluxes generated by the current in the windings are mutually enhanced in the second magnetically permeable core.

Optionally, the relative permeability of the first magnetic material is higher than 200; and the relative permeability of the second magnetic material is lower than 200.

Optionally, at least two pairs of power Vin and power GND are provided, each pair of power Vin and power GND are respectively arranged side by side on one side surface of the magnetically permeable core, and the signal connector is arranged on one side surface of the magnetically permeable core which is not provided with the power Vin and the power GND; a metal shielding layer is arranged between the connector and the magnetically permeable core, and the connector and the metal shielding layer are electrically isolated.

Optionally, the connector and the second magnetically permeable core are integrally pressed and formed.

Optionally, the connector and the shielding layer are both arranged on at least one PCB assembly, and the at least one PCB assembly and the inductor assembly form the integrated coupled inductor through assembly.

Optionally, the number of the windings is N, and N is greater than 2; the number of the magnetic columns is N, and the magnetic columns are in one-to-one correspondence with the windings;

wherein the second magnetically permeable core is arranged between two adjacent magnetic columns, specifically:

wherein the second magnetically permeable core is N−1, and the magnetic column and the second magnetically permeable core are alternately arranged.

Optionally, a first air gap is formed in the magnetic column, and a second air gap is formed in the second magnetically permeable core; the first air gap is arranged in a symmetrical and unbalanced mode, and/or the second air gap is arranged in a symmetrical and unbalanced mode; the magnetic column and/or the second magnetically permeable core are arranged from one side surface of the inductor assembly to another side surface in a symmetrical mode, and the first air gap and/or the second air gap are sequentially increased from the edge to the center of the inductor assembly; and the first air gap and/or the second air gap which are symmetrical in center are equal in size.

Optionally, the at least two windings are wound on the same magnetic column of the first magnetically permeable core; the second magnetically permeable core is annular or arc-shaped, and the second magnetically permeable core surrounds the at least one magnetic column and is arranged between the at least two windings.

In general, another aspect features a multi-phase VRM comprises:
at least one integrated coupled inductor of claims 1 to 9, both the first pad and the second pad being adjacent to a first side surface of the inductor assembly;
wherein a top plate comprises an IPM unit and a passive element;
wherein a side conductive connector comprises a signal conductive connector and a power conductive connector, and the side conductive connector is arranged on another side surface, different from the first side surface, of the multi-phase VRM;
wherein the IPM unit is electrically connected with a first bonding pad of a corresponding winding, and the second bonding pad is used for being electrically connected with a load.

Optionally, the IPM unit is arranged at the position, close to the first side surface, of the top plate, and the IPM unit is arranged in a mode perpendicular to the winding.

Optionally, the passive element comprises an input capacitor, at least two IPM units are provided, and at least a part of the input capacitor is arranged between two adjacent IPM units.

Optionally, the passive element comprises an input capacitor, the number of the IPM units is more than two, and at least a part of the input capacitor is arranged between every two adjacent IPM units.

The details of one or more embodiments of the invention are set forth in the accompanying drawings and description below. Other features, objects, and advantages of the invention will be apparent from the description and drawings, and from the claims.

### BRIEF DESCRIPTION OF THE DRAWINGS

FIG. 1A to FIG. 1B are schematic diagrams of the prior art.

FIG. 2A to FIG. 2G are schematic diagrams of Embodiment 1.

FIG. 3A to FIG. 3E are schematic diagrams of Embodiment 2.

FIG. 4A to FIG. 4D are schematic diagrams of Embodiment 3.

FIG. 5 to FIG. 6H are schematic diagrams of Embodiment 4.

FIG. 7A to FIG. 7G are schematic diagrams of Embodiment 5.

FIG. 8A to FIG. 8B are schematic diagrams of Embodiment 6.

### DESCRIPTION OF THE EMBODIMENTS

The present application discloses various embodiments or examples of implementing the thematic technological schemes mentioned. To simplify the disclosure, specific instances of each element and arrangement are described below. However, these are merely examples and do not limit the scope of protection of this invention. For instance, a first feature recorded subsequently in the specification formed above or on top of a second feature may include an embodiment where the first and second features are formed through direct contact, or it may include an embodiment where additional features are formed between the first and second features, allowing the first and second features not to be directly connected. Additionally, these disclosures may repeat reference numerals and/or letters in different examples. This repetition is for brevity and clarity and does not imply a relationship between the discussed embodiments and/or structures. Furthermore, when a first element is described as being connected or combined with a second element, this includes embodiments where the first and second elements are directly connected or combined with each other, as well as embodiments where one or more intervening elements are introduced to indirectly connect or combine the first and second elements.

### Embodiment 1

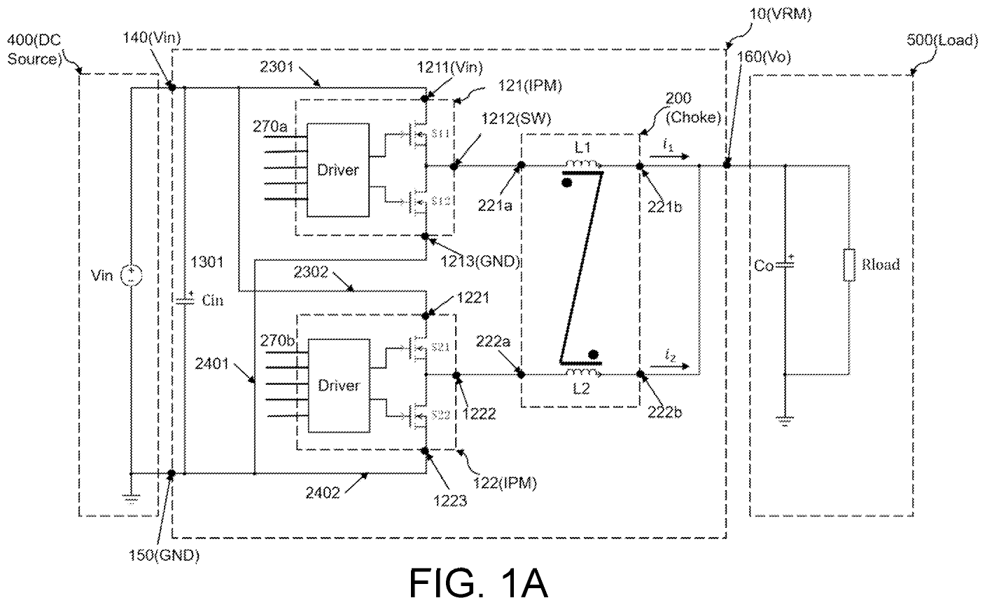

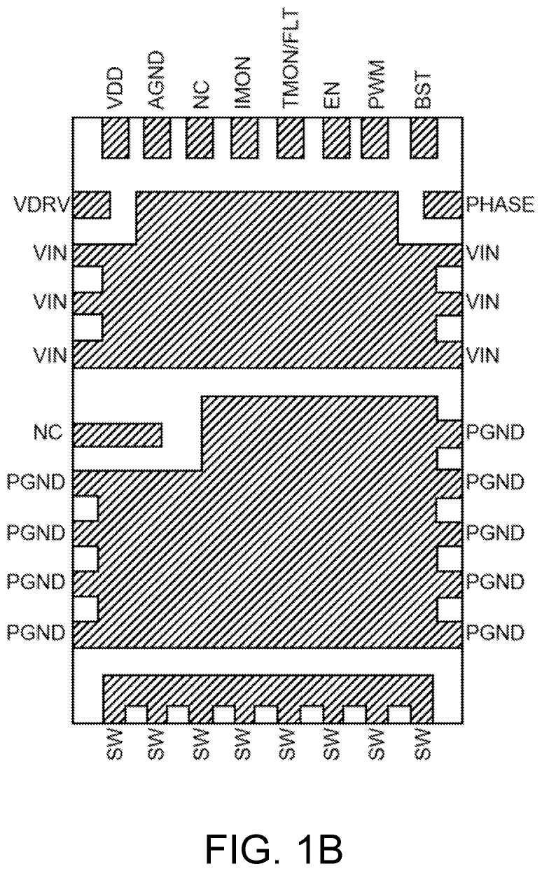

FIG. 1A shows a circuit diagram of a multiphase VRM of this embodiment, a complete multi-phase VRM 10 (here is a two-phase VRM), comprises an IPM unit 121, an IPM unit 122, an integrated coupled inductor 200, a power VIN 2301, a power VIN 2302, a power GND 2401, a power GND 2402, an input capacitor 1301, a signal conductive connector 270a, and a signal conductive connector 270b, wherein each IPM unit comprises two switching devices, a high-end MOSFET and a low-end MOSFET, and the two MOSFETs are connected in series to form a bridge arm; one end of the bridge arm is connected to the positive end of the input power, i.e., the power VIN 140; the other end of the bridge arm is connected with the ground end, i.e., the power GND 150. The midpoint of bridge arm (the switch point, recorded as SW 1212 and SW 1222) is connected to the input end of the inductor, the output ends of the inductors are connected in parallel or not connected in parallel and then connected with the load to provide energy for the load. The input capacitor 1301 is used to bypass high frequency switch ripple current to ensure that the input voltage is stable. The signal conductive connector 270a and the signal conductive connector 270b are respectively used for the transmission of signals such as drive and control of the IPM unit 121 and the IPM unit 122. The integrated coupled inductor 200 integrates the power VIN 2301, the power VIN 2302, the power GND 2401, the power GND 2402, the signal conductive connector 270a, and the signal conductive connector 270b.

FIG. 1B shows a packaging diagram of a standard IPM unit in the prior art. A connection point SW of the high-end MOSFET and the low-end MOSFET is arranged at one side of the IPM unit, and connection Pads for control signal and the like are arranged at the side opposite to the connection point SW, and the input power connection end VIN and GND are arranged in the middle accordingly.

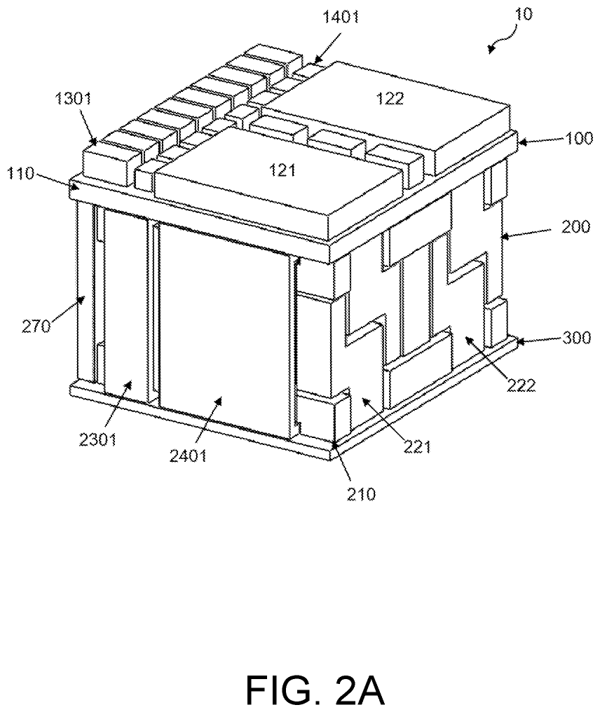

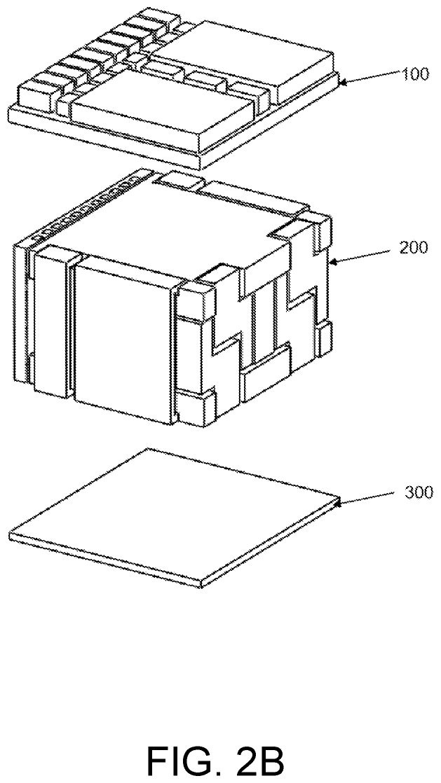

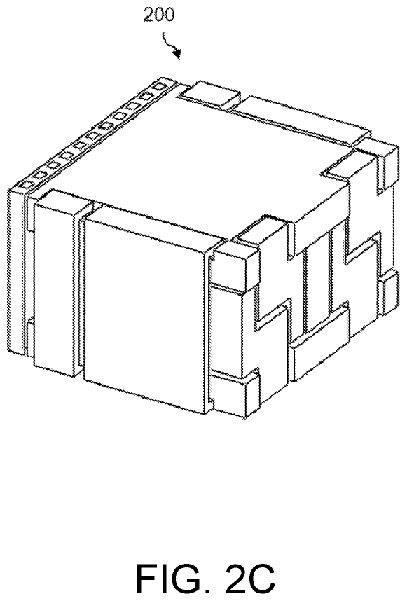

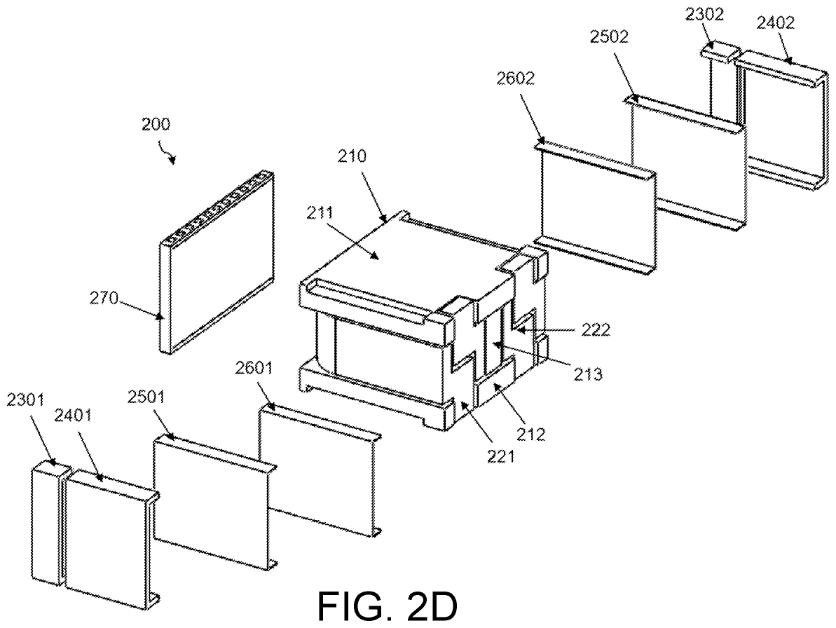

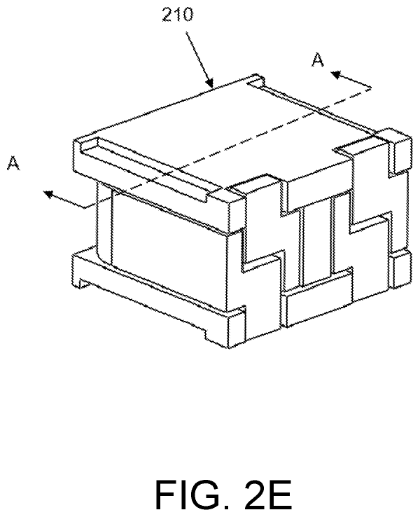

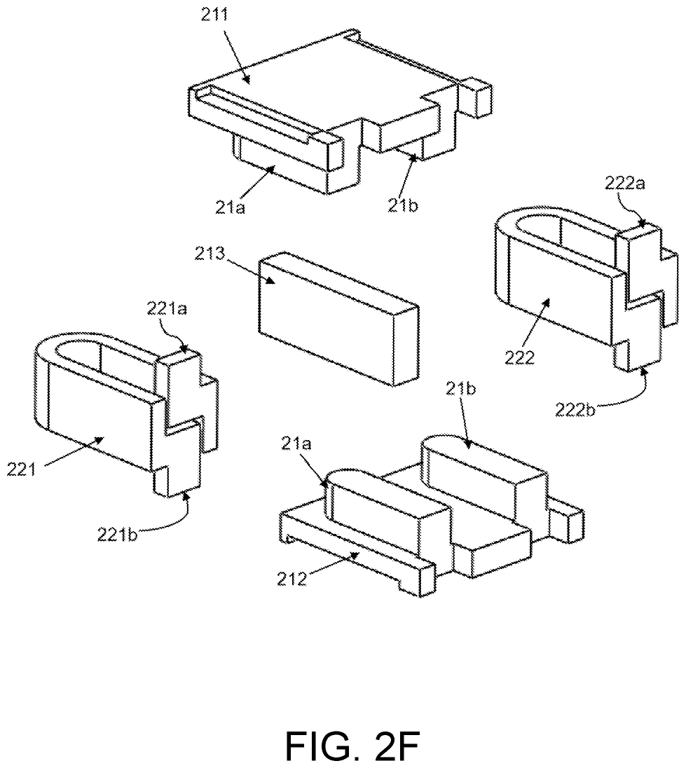

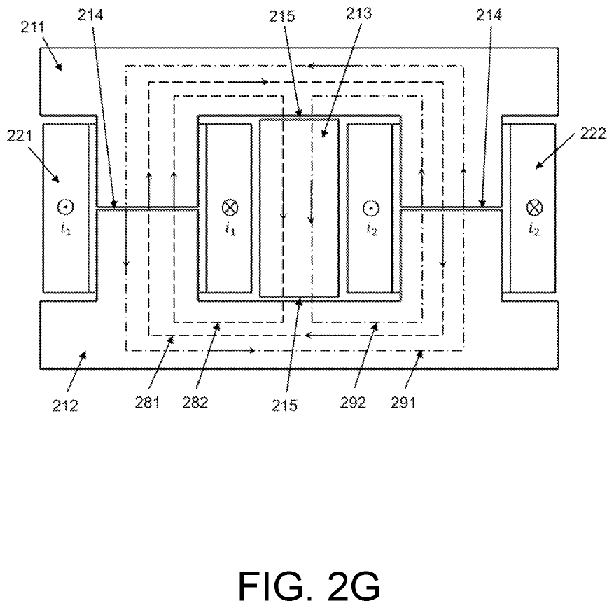

FIG. 2A is a schematic structural diagram of the two-phase VRM in this embodiment, FIG. 2B is an exploded view, FIG. 2C is a schematic structural diagram of the integrated coupled inductor 200 in FIG. 2B, FIG. 2D is an exploded view of the integrated coupled inductor 200, FIG. 2E is a schematic structural diagram of the inductor 210 in FIG. 2D, FIG. 2F is an exploded view of the inductor 210 coupled in FIG. 2E, and FIG. 2G is a cross-sectional view section A-A in FIG. 2E. As shown in FIG. 2A and FIG. 2B, the two-phase VRM comprises a top plate 100, an integrated coupled inductor 200 and a bottom plate 300; the top plate 100 comprises a mainboard PCB 110, an IPM unit 121, an IPM unit 122, an input capacitor 1301 and other passive element 1401; the IPM unit 121 and the IPM unit 122 are arranged close to the edge of the mainboard PCB 110, since on IPM unit 121, the connection points of high-end MOSFET to low-end MOSFET are provided at edge of IPM unit 121, and IPM unit 121 is provided at edge of mainboard PCB 110 in order to facilitate input end of inductor to be connected directly to SW end of IPM unit 121, and to reduce loss of efficiency caused by lateral currents; the other passive element 1401 mainly a passive element of a control signal loop in the IPM unit 121, and a control signal of the IPM unit 121 is arranged at the other end opposite to the SW, so that the passive element 1401 needs to be close to the IPM unit 121 to achieve the effects of good filtering and the like, and therefore the passive element 1401 is arranged close to the IPM unit; and the input capacitor 1301 is divided into two parts, one part of the input capacitor 1301 is arranged at the edge of the other end of the mainboard PCB 110 and is close to other passive element 1401; and one part is arranged between the two IPM units, because the input capacitor 1301 is closer to the VIN input end of the IPM unit 121 and the IPM unit 122, the better the filtering effect is, and the VIN ends on the IPM unit 121 and the IPM unit 122 are arranged on the side close to the control signal.

As shown in FIG. 2D, the integrated coupled inductor 200 comprises a coupled inductor 210, a signal conductive connector 270, a power conductive connector (comprising a power VIN 2301, a power VIN 2302 and a power GND 2401, a power GND 2402), a copper sheet 2601, a copper sheet 2602, an insulating layer 2501, and an insulating layer 2502. The copper sheets are used to reduce the parasitic inductance of a loop formed by the power Vin and the power GND; the existence of the parasitic inductance will form an oscillation loop with the input capacitor 1301, and when the resonance point of the oscillation loop is close to the switching frequency of the switching device, the oscillation amplitude is increased, so that the efficiency of the power circuit is reduced, and a metal layer is added to reduce the parasitic inductance of the power Vin-power GND loop to solve the problem.

The power Vin and the power GND in this embodiment can also be realized through a PCB Trace method, the signal conductive connector 270 can also be realized in a PCB Trace mode, a copper layer is additionally arranged between the signal conductive connector 270 and the magnetically permeable core and used for shielding electromagnetic interference, the copper layer can also be connected with the power GND, electric field shielding is achieved, it is ensured that the signal conductive connector 270 cannot be subjected to electromagnetic interference, and reliable work of the IPM unit 121 is ensured.

As shown in FIG. 2E and FIG. 2F, the coupled inductor 210 comprises a first magnetically permeable core 211, a first magnetically permeable core 212, a second magnetically permeable core 213, a first winding 221 and a second winding 222. In this embodiment, the first magnetically permeable core comprises a cover plate and a magnetic column (i.e., a first magnetic column 21a and a second magnetic column 21b), and the second magnetically permeable core 213 is arranged between the first magnetic column 21a and the second magnetic column 21b; the first winding 221 is arranged on the first magnetic column 21a, and the second winding 222 is arranged on the second magnetic column 21b; and the first winding 221 is provided with a first bonding pad 221a and a second bonding pad 221b; and the second winding 222 is provided with a first bonding pad 222a and a second bonding pad 222b; the first bonding pad 221a and the first bonding pad 222a are respectively connected to the SW of the IPM unit; the second bonding pad 221b and the second bonding pad 222b are connected together and then connected to a load; it can be seen from FIG. 2A, FIG. 2B and FIG. 2F that the first bonding pads of the winding are directly and vertically connected to the SW pad of the IPM unit, and no transverse PCB Trace is passed on the mainboard PCB 110; therefore, the winding structure can improve the efficiency of the VRM.

As shown in FIG. 2G, the magnetic flux generated by the current in the first winding 221 is a main magnetic flux 281 and a magnetic flux leakage 282; and the magnetic flux generated by the current in the second winding 222 is a main magnetic flux 291 and a leakage flux 292; the current in the winding flows from the first bonding pad to the second bonding pad, i.e., the current flows to the load from the SW; because of the direction of the main magnetic flux 281 generated by the current in the first winding is opposite to the direction of the main magnetic flux 291 generated by the current in the second winding, and the main magnetic flux 281 and the main magnetic flux 291 generated by the current in the second winding are mutually counteracted; so, the two-phase inductor in this embodiment works in an anti-coupled state; and because of the leakage flux 282 generated by the current in the first winding and the leakage flux 292 generated by the current in the second winding have the same direction in the second magnetically permeable core and the leakage flux 282 generated by the current in the first winding and the leakage flux 292 generated by the current in the second winding are mutually enhanced; because of the main magnetic flux 281 and the main magnetic flux 291 are mutually counteracted, and the magnetic flux path of the main magnetic flux is mainly the first magnetically permeable core, the saturation stress of the first magnetically permeable core is small, the first magnetic conductive material with the relative permeability higher than 200 can be arranged, and the ferrite material is low in saturation characteristic, high in permeability and low in magnetically permeable core loss density, so that a relatively high coupled coefficient and relatively low magnetically permeable core loss are obtained. The leakage flux 282 and the leakage flux 292 are mutually enhanced in the second magnetically permeable core, so that the saturation stress of the second magnetically permeable core is large, and the second magnetically permeable core can be arranged to be a second magnetic conductive material with the relative permeability lower than 200, such as a powder core material with good saturation characteristics, such as an iron powder core, iron silicon, an iron-nickel powder core, an amorphous powder core, a nanocrystalline powder core and the like, so as to obtain a relatively high saturation current.

As shown in FIG. 2G, the two magnetic columns of the first magnetically permeable core are provided with a first air gap 214; and a second air gap 215 is provided between the second magnetically permeable core and the first magnetically permeable core (in other embodiments, the air gap may also be an assembly air gap); the first air gap 214 is used to adjust the size of the main magnetic flux, i.e., the mutual inductance or the coupled coefficient is adjusted; the second air gap 215 is used to adjust the leakage flux or the leakage inductance; the existence of the air gap can flexibly adjusts the leakage inductance and the mutual inductance according to the application so as to meet different application scenes; and the leakage inductance can be adjusted by adjusting the permeability of the second magnetically permeable core.

### Embodiment 2

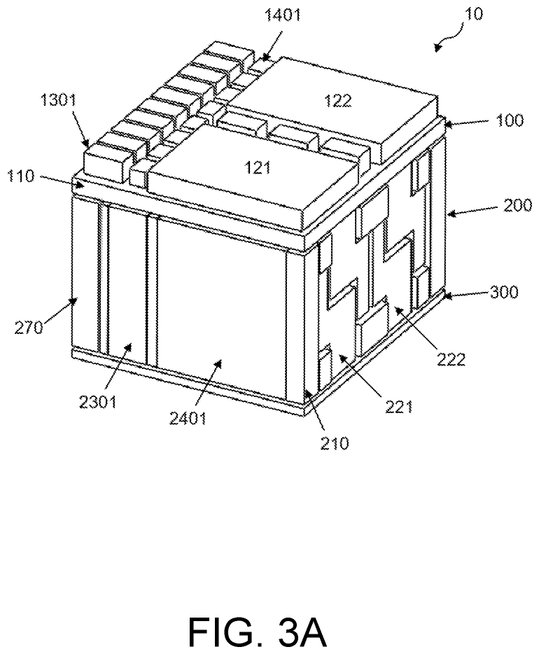

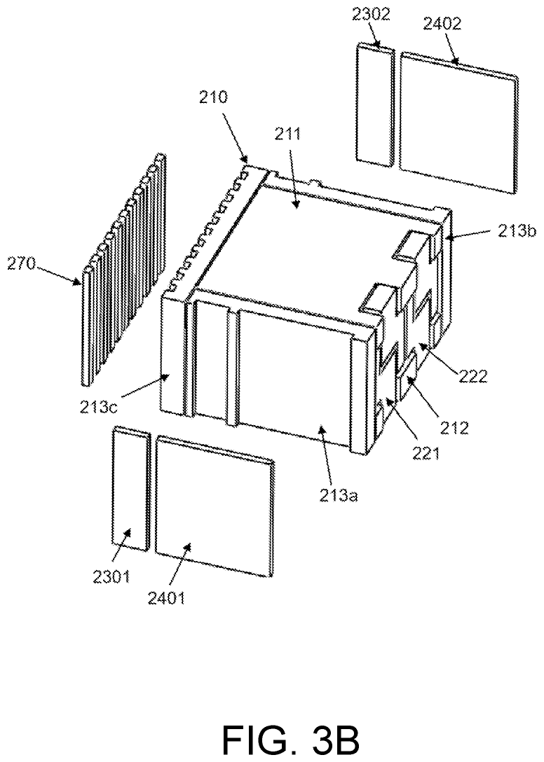

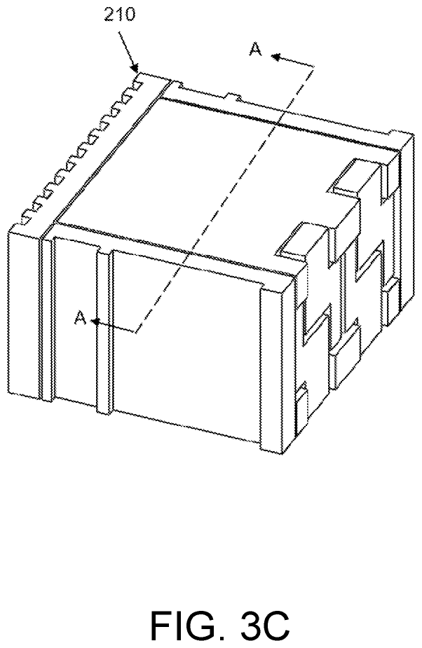

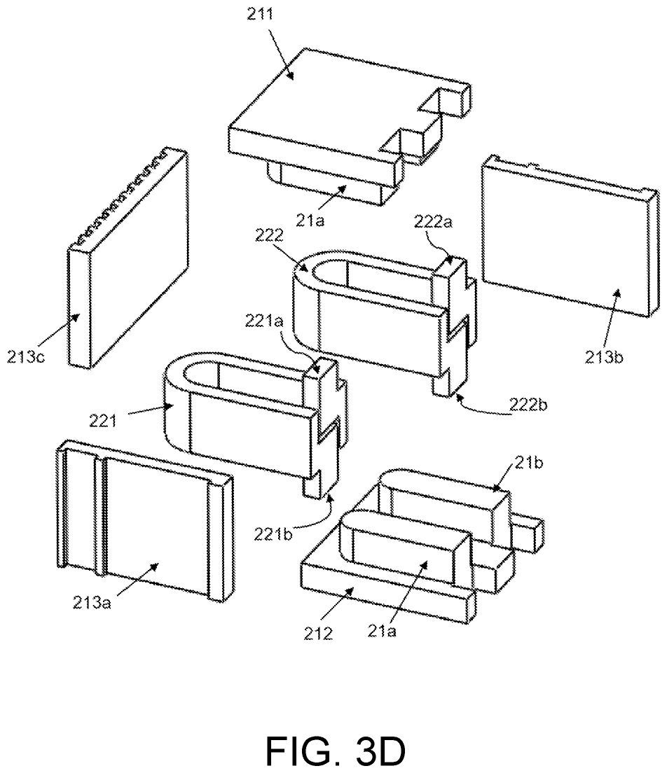

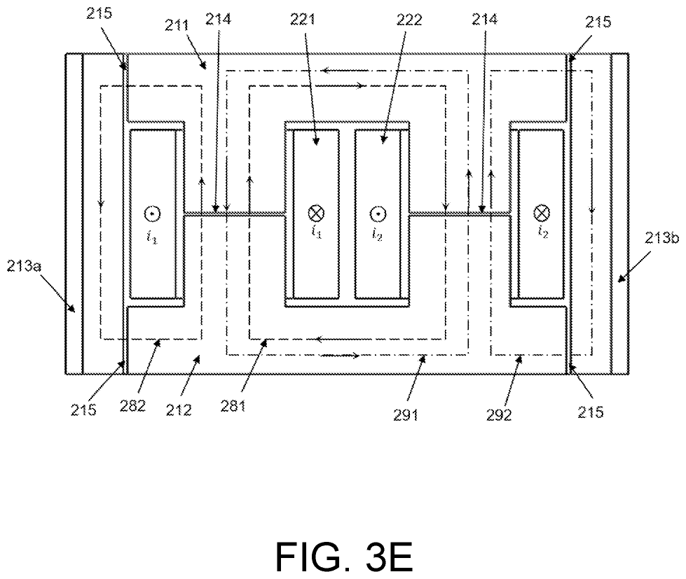

FIG. 3A is a schematic structural diagram of a two-phase VRM of this embodiment, FIG. 3B is an exploded view of the integrated coupled inductor 200 shown in FIG. 3A, FIG. 3C is a schematic structural diagram of the coupled inductor 210 in FIG. 3B, FIG. 3D is an exploded view of the inductor 210 shown in FIG. 3C, and FIG. 3E is a cross-sectional view section A-A in FIG. 3C. The difference between this embodiment and the Embodiment 1 is that the integrated coupled inductor 200 and the coupled inductor 210 in this embodiment are different in structure, as shown in FIG. 3B, the integrated coupled inductor 200 comprises a coupled inductor 210, a signal conductive connector 270, a power VIN 2301, a power VIN 2302, a power GND 2401 and a power GND 2402; as shown in FIG. 3C and FIG. 3D, the coupled inductor 210 comprises a first magnetically permeable core 211, a first magnetically permeable core 212, a second magnetically permeable core 213a, a second magnetically permeable core 213b, a second magnetically permeable core 213c, a first winding 221 and a second winding 222; the second magnetically permeable core 213a, the second magnetically permeable core 213b and the second magnetically permeable core 213c are arranged on the side of the first magnetically permeable core 211 and the first magnetically permeable core 212.

The difference between this embodiment and the Embodiment 1 is that the implementation modes of the connectors (i.e., the power Vin, the power GND and the signal conductive connector 270) are different, the connectors and the second magnetically permeable core in this embodiment are integrally pressed and synthesized and sintered together, and then the connectors and the second magnetically permeable core are assembled together with the first magnetically permeable core and the winding.

According to this embodiment, the structure form of the windings and the connection between the windings input end and the SW and the connection between the windings output end and the load are the same as those of the Embodiment 1; thus, the structural arrangement of the windings can improve the efficiency of the VRM;

As shown in FIG. 3E, the magnetic flux generated by the current in the first winding 221 is a main magnetic flux 281 and a magnetic flux leakage 282; and the magnetic flux generated by the current in the second winding 222 is a main magnetic flux 291 and a leakage flux 292; since the current in the winding flows from the first bonding pad to the second bonding pad, i.e., the current flows to the load from the SW, because of the direction of the main magnetic flux 281 generated by the current in the first winding is opposite to the direction of the main magnetic flux 291 generated by the current in the second winding, and the main magnetic flux 281 and the main magnetic flux 291 generated by the current in the second winding are mutually counteracted. The two-phase inductor in this embodiment works in an anti-coupled state; the leakage flux 282 generated by the current in the first winding and the leakage flux 292 generated by the current in the second winding flow in the second magnetically permeable core, and the leakage flux generated by the current in the first winding mainly flows in the second magnetically permeable core 213a close to the first winding; and the leakage flux generated by the current in the second winding mainly flows in the second magnetically permeable core 213b close to the second winding; and the leakage flux of the first winding and the leakage flux of the second winding are in the same direction in the second magnetically permeable core 213c, are mutually enhanced. Since the main magnetic flux 281 and the main magnetic flux 291 are mutually counteracted, and the magnetic flux path of the main magnetic flux is mainly the first magnetically permeable core, the saturation stress of the first magnetically permeable core is small, and the first magnetically permeable core can be set to be a ferrite material with low saturation characteristics, high permeability and low magnetically permeable core loss density.

The two magnetic columns of the first magnetically permeable core are provided with a first air gap 214; and a second air gap 215 (which may also be an assembly gap) is provided between the second magnetically permeable core and the first magnetically permeable core; the first air gap 214 is used to adjust the size of the main magnetic flux, i.e., the mutual inductance or the coupled coefficient is adjusted; the second air gap 215 is used to adjust the leakage flux or the leakage inductance; the existence of the air gap can flexibly adjust the leakage inductance and the mutual inductance according to the application so as to meet different application scenes; and the leakage inductance can be adjusted by adjusting the permeability of the second magnetically permeable core.

The advantage of this embodiment is that the connector is integrally formed with the second magnetically permeable core, reducing the difficulty of assembling the connector.

### Embodiment 3

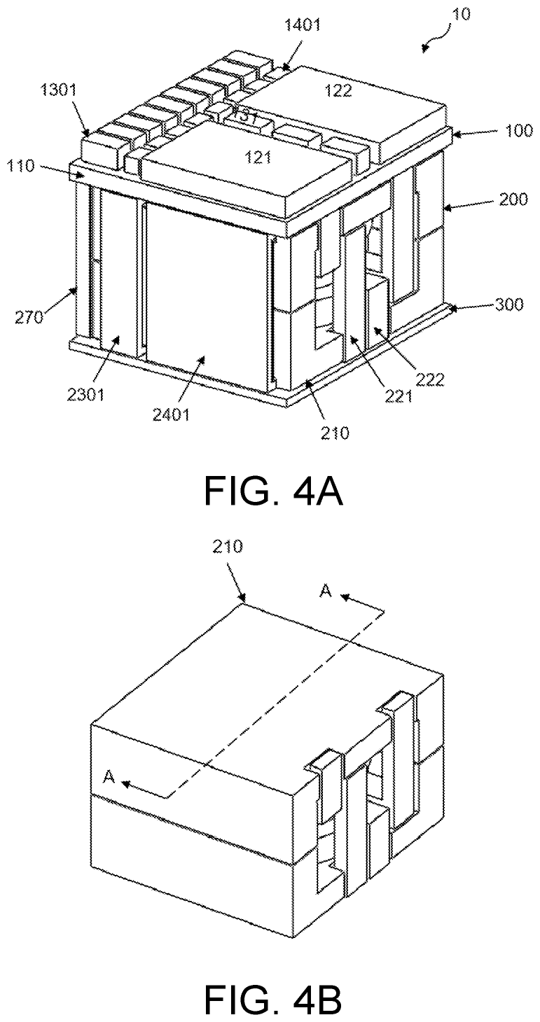

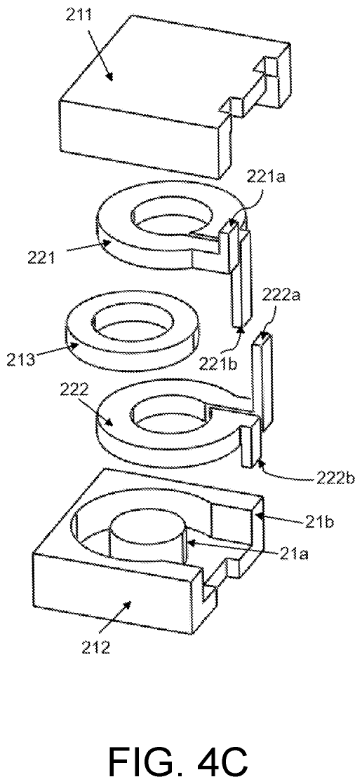

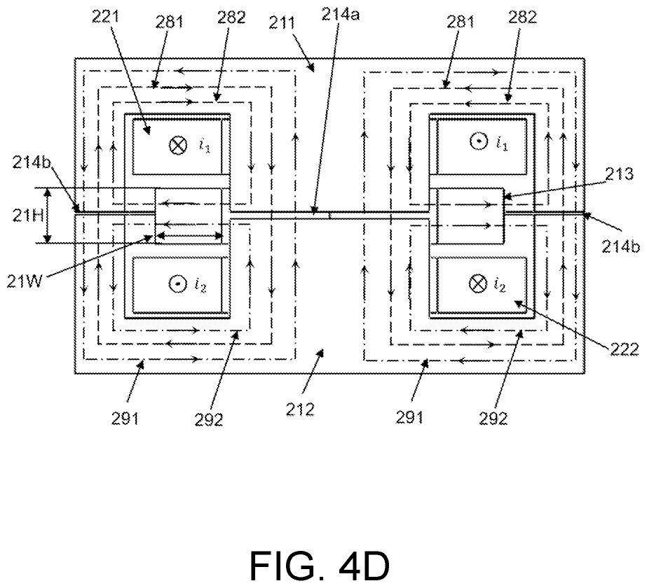

FIG. 4A is a schematic structural diagram of a two-phase VRM in this embodiment; FIG. 4B is a schematic structural diagram of a coupled inductor 210, FIG. 4C is an exploded view of a coupled inductor 210, and FIG. 4D is a cross-sectional view of A-A in FIG. 4B. The difference between this embodiment and the Embodiment 1 is that the structure of the coupled inductor 210 in this embodiment is different, as shown in FIG. 4B and FIG. 4C, the coupled inductor 210 comprises a magnetically permeable core (comprising a first magnetically permeable core 211, a first magnetically permeable core 212 and a second magnetically permeable core 213), a first winding 221 and a second winding 222. In this embodiment, the first magnetically permeable core comprises a cover plate, a first magnetic column 21a and a second magnetic column 21b, and the first magnetic column 21a is arranged at the central position of the magnetically permeable core; the second magnetically permeable core 213 is of an annular or segmented arc shape, is arranged around the first magnetic column 21a and is arranged between the first winding 221 and the second winding 222; the first winding 221 and the second winding 222 are respectively arranged on the first magnetic column 21a, and the second magnetic column 21b is arranged around a stack formed by the first winding 221, the second magnetically permeable core 213 and the second winding 222.

In this embodiment, the connection between the winding input end and the SW and the connection between the winding output end and the load are the same as that of the Embodiment 1; therefore, the structural arrangement of the windings can improve the efficiency of the VRM.

As shown in FIG. 4D, the magnetic flux generated by the current in the first winding 221 is a main magnetic flux 281 and a magnetic flux leakage 282; and the magnetic flux generated by the current in the second winding 222 is a main magnetic flux 291 and a leakage flux 292; since the current in the winding flows from the first bonding pad to the second bonding pad, i.e., the current flows to the load from the SW, because of the direction of the main magnetic flux 281 generated by the current in the first winding is opposite to the direction of the main magnetic flux 291 generated by the current in the second winding, and the main magnetic flux 281 and the main magnetic flux 291 generated by the current in the second winding are mutually counteracted. The two-phase inductor in this embodiment works in an anti-coupled state; because of the leakage flux 282 generated by the current in the first winding and the leakage flux 292 generated by the current in the second winding have the same direction in the second magnetically permeable core and the leakage flux 282 generated by the current in the first winding and the leakage flux 292 generated by the current in the second winding are mutually enhanced. Since the main magnetic flux 281 and 291 are mutually counteracted, and the magnetic flux path of the main magnetic flux is mainly the first magnetically permeable core, thus the saturation stress of the first magnetically permeable core is small, and the first magnetically permeable core can be set to be a ferrite material with low saturation characteristic, but high permeability and low magnetically permeable core loss density; a relatively high coupled coefficient and relatively low magnetically permeable core loss are obtained; the magnetic flux leakage flux 282 and 292 flow in the second magnetically permeable core, and the directions are the same and are mutually enhanced. Therefore, the saturation stress of the second magnetically permeable core is large, and the second magnetically permeable core can be set as a powder core magnetic material with good saturation characteristics, such as an iron powder core, iron silicon, an iron-nickel powder core, an amorphous powder core, a nanocrystalline powder core and the like; and high saturation current is obtained.

The first magnetic column 21a is provided with a first air gap 214a, and an assembly air gap 214b is provided on the second magnetic column (this embodiment takes an assembled air gap as an example, but the air gap on the second magnetic column is not limited to be an assembled air gap, or may be a second air gap); generally, the first air gap 214a is a main air gap, and the first air gap 214a is larger than the assembly air gap 214b; so that the problem of electromagnetic interference caused by an air gap can be reduced, and the first air gap 214a can be arranged to be equal to the size of the assembled air gap 214b so as to reduce the alternating current loss of the winding caused by overlarge air gap; and the second magnetically permeable core 213 is provided with a second magnetically permeable core width 21W and a second magnetically permeable core thickness 21H; the first air gap 214 is used to adjust the size of the main magnetic flux, i.e, the mutual inductance or coupled coefficient is adjusted; the second magnetically permeable core width 21W and the second magnetically permeable core thickness 21H are used to adjust the leakage flux or the leakage inductance; the air gap and the second magnetically permeable core 213 can be used to flexibly adjust the mutual inductance and leakage inductance so as to meet different application scenes; and the leakage inductance can be adjusted by adjusting the permeability of the second magnetically permeable core 213.

This embodiment has the advantages that the mounting mode of the first magnetically permeable core and the second magnetically permeable core is simple, the three side surfaces of the first magnetically permeable core can be used for installing the power PIN and the signal connector, and the magnetic flux leakage cannot generate interference or loss on the power PIN or the signal connector.

### Embodiment 4

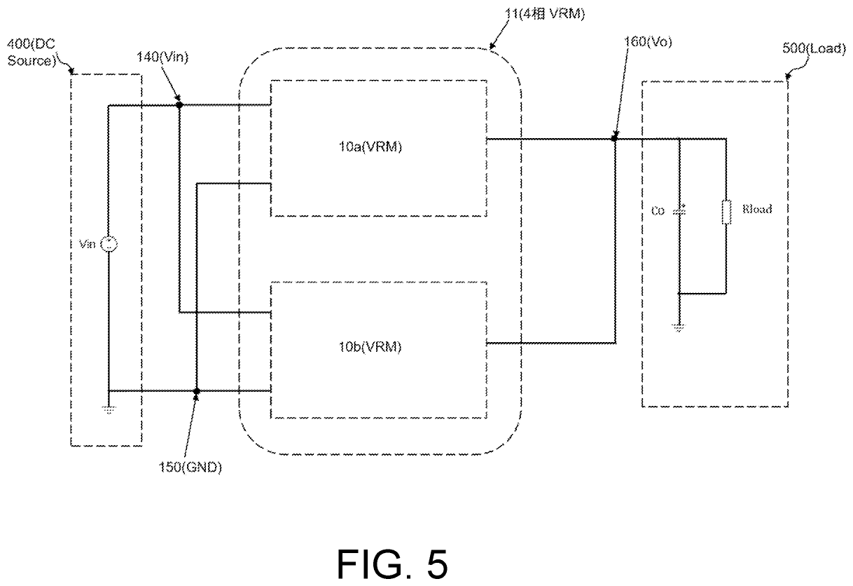

FIG. 5 is a schematic diagram of an application principle of a four-phase VRM; as shown in FIG. 5, the four-phase VRM comprises two-phase VRM in parallel, and the input and output of the VRM of the two phases are connected in parallel, so that a four-phase VRM can be formed; the four-phase VRM is formed by integrating the two-phase VRM 10a and the two-phase VRM 10b; the inductance in the four-phase VRM is also formed by a four-phase integrated coupled inductor; the following embodiments are used for explaining the integration of the four-phase VRM; certainly, the four phases are only one example, and the structure and the method of this invention can be applied to a multi-phase VRM with any more than 2;

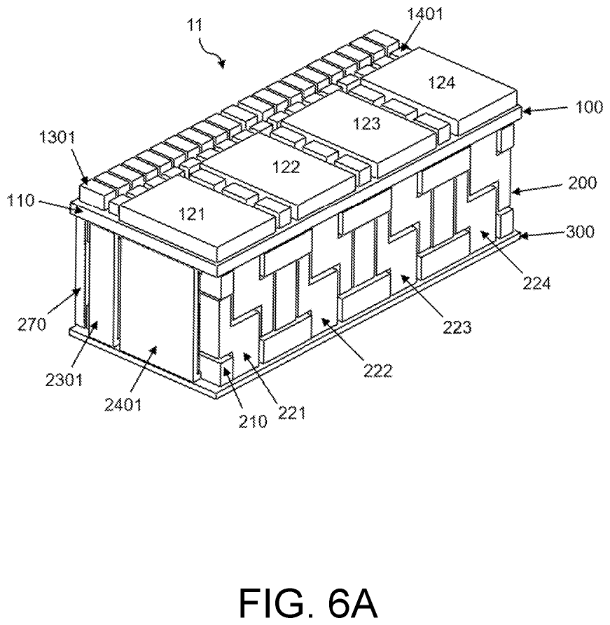

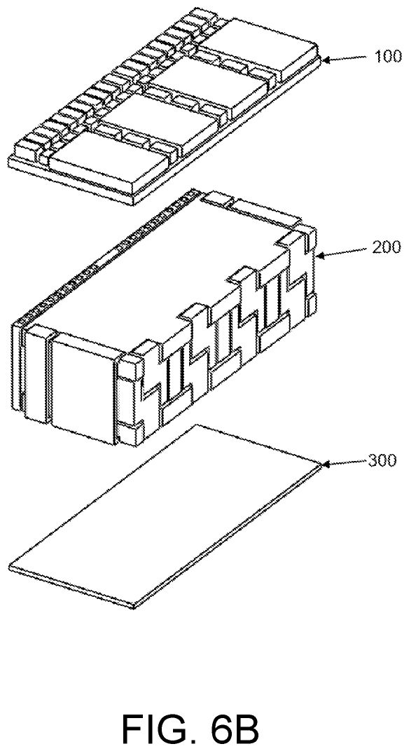

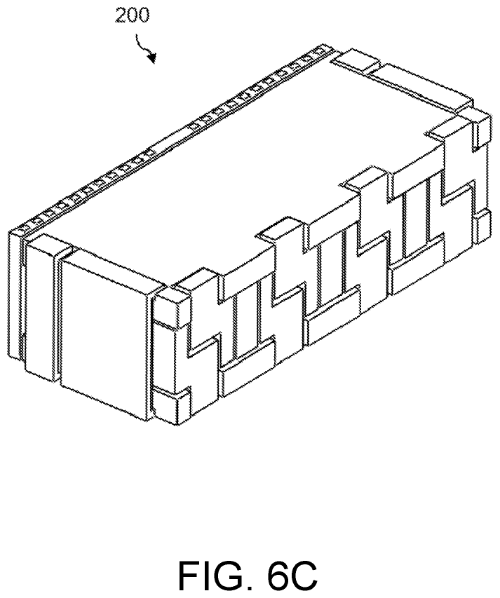

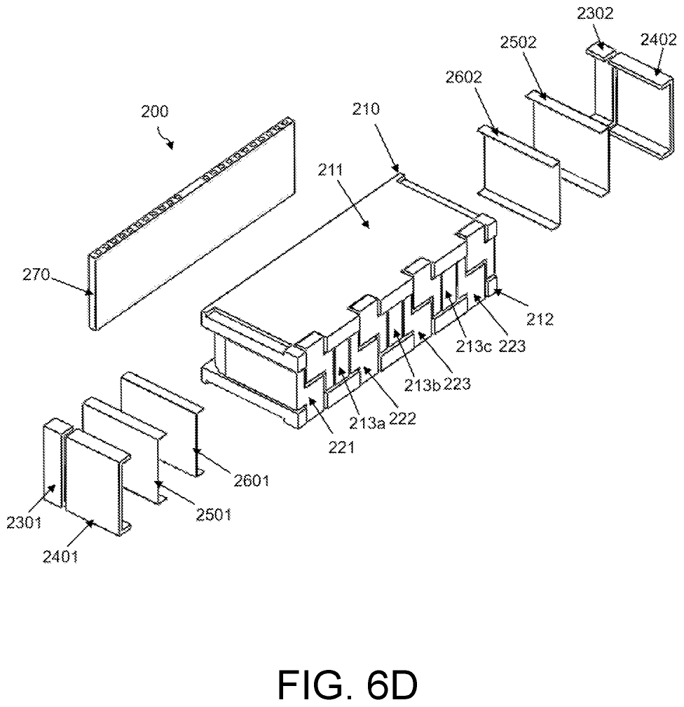

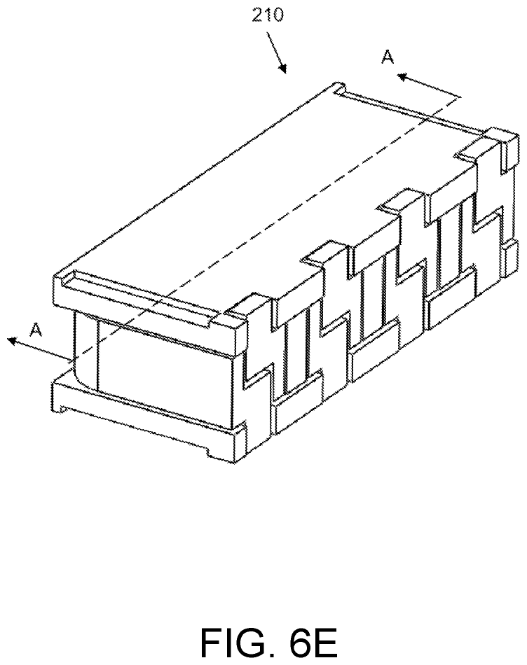

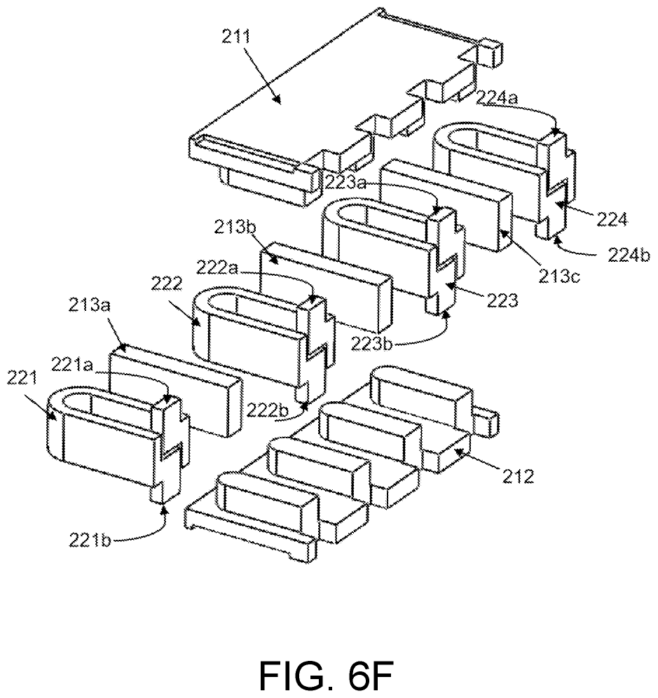

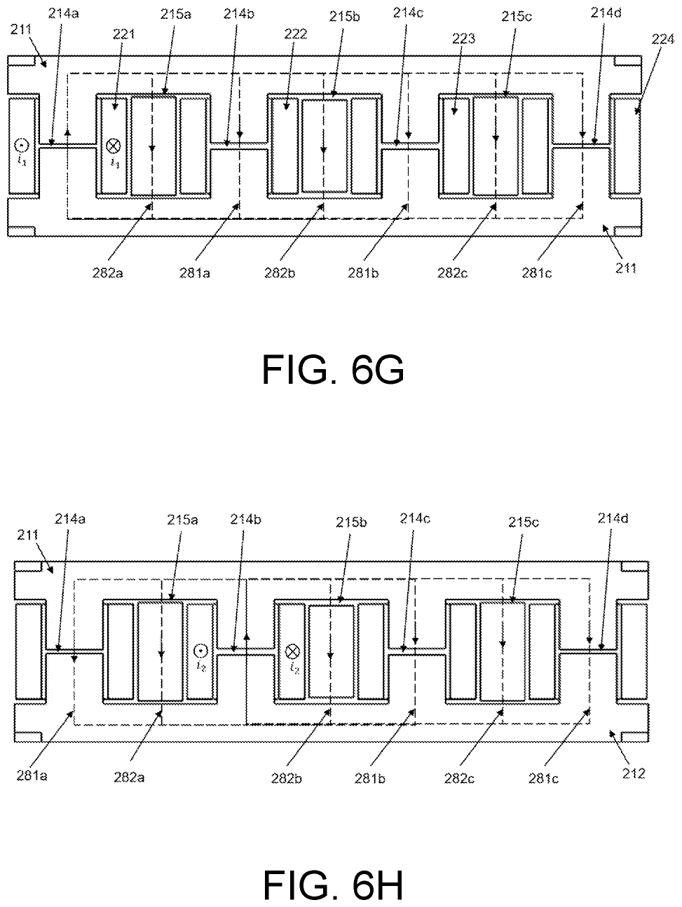

FIG. 6A is a schematic structural diagram of the four-phase VRM in this embodiment, and FIG. 6B is an exploded view; FIG. 6C is a schematic structural diagram of the integrated coupled inductor 200; FIG. 6D is an exploded view of the integrated coupled inductor 200; FIG. 6E is a schematic structural diagram of the coupled inductor 210 in FIG. 6E; FIG. 6F is an exploded view of the coupled inductor 210; and FIG. 6G and FIG. 6H are cross-sectional views of the section A-A in FIG. 6E. As shown in FIG. 6A and FIG. 6B, the difference between this embodiment and the Embodiment 1 is that this embodiment is a four-phase VRM, but the technical principle is the same as that of the Embodiment 1; and the difference between the embodiment and the Embodiment 1 is that the first air gap 214a, the first air gap 214b, the first air gap 22c and the first air gap 214d are arranged in this embodiment.

In this embodiment, the magnetic circuit lengths of the mutual magnetic flux paths between any phase and the other three phases are different, so that the coupled coefficients between any two phases are different; in order to adjust the phenomenon of unequal coupled coefficients caused by unequal lengths of any two-phase magnetic circuits, the mutual coupled consistency between the four-phase inductors is achieved, an unbalanced and symmetrical air gap setting method can be adopted, and the air gap sizes of the first phase and the fourth phase are set to be equal, that is, the sizes of the first air gap 214a and the first air gap 214d are the same; the sizes of the air gaps of the second phase and the third phase are set to be equal, that is, the size of the first air gap 214b is the same as that of the first air gap 214c; and the first air gap 214b and the first air gap 214c are set to be both larger than the first air gap 214a and the first air gap 214d, which is an unbalanced setting, in this way, the coupled coefficient balance between any two phases between the four phases can be achieved, the ripple size of the multi-phase output current can be balanced through coupled coefficient balance, and the dynamic performance and efficiency of the VRM can be further improved.

Preferably, in some other multiphase VRMs, the magnetic columns form an array in the direction of the winding forming array, the magnetic columns are sequentially paired in a head-to-tail correspondence relationship, each pair of magnetic columns has a first air gap with the same size, and the size of the first air gap is sequentially increased from the two ends of the array to the middle; the second magnetically permeable cores are sequentially paired in a head-to-tail correspondence relationship, each pair of second magnetically permeable cores has a second air gap with the same size, and the size of the second air gap is sequentially increased from the two ends of the array to the middle.

The leakage flux in this embodiment also has the same problem, and the magnetic circuit lengths of the magnetic flux leakage path and the magnetic flux leakage path between any two phases are different, so that the leakage inductance of each phase is inconsistent; the problem can also be solved by symmetrically unbalanced settings, that is, the second air gap 215a on the first magnetic flux leakage path is equal to the second air gap 215c on the third magnetic flux leakage path and is smaller than the second air gap 215b on the second magnetic flux leakage path, and the three-phase leakage inductance can be consistent in size.

### Embodiment 5

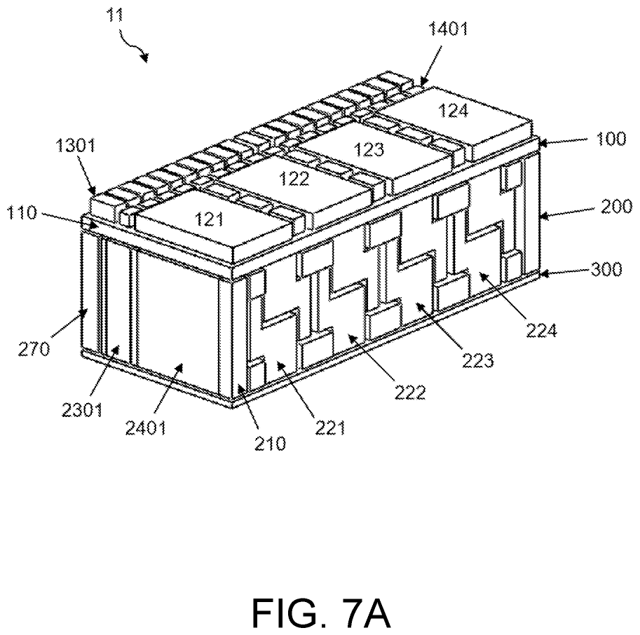

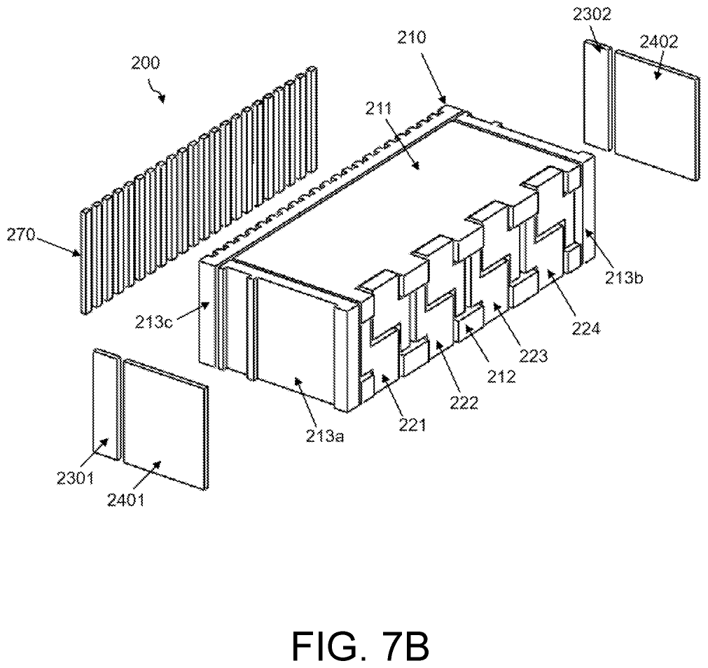

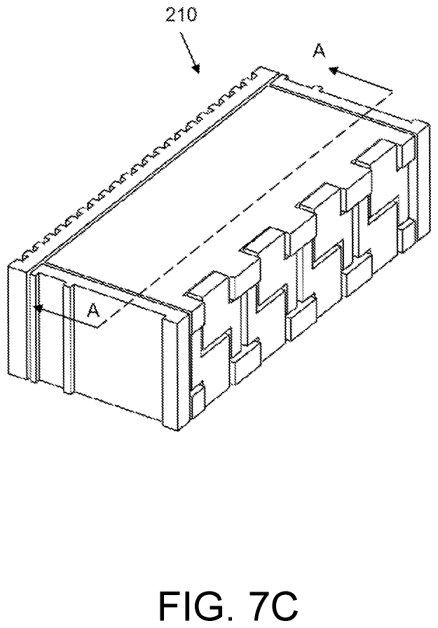

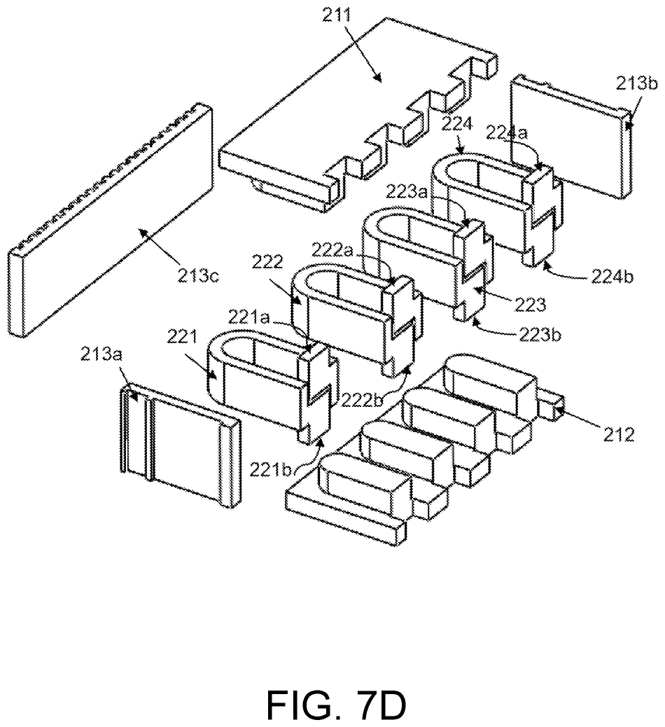

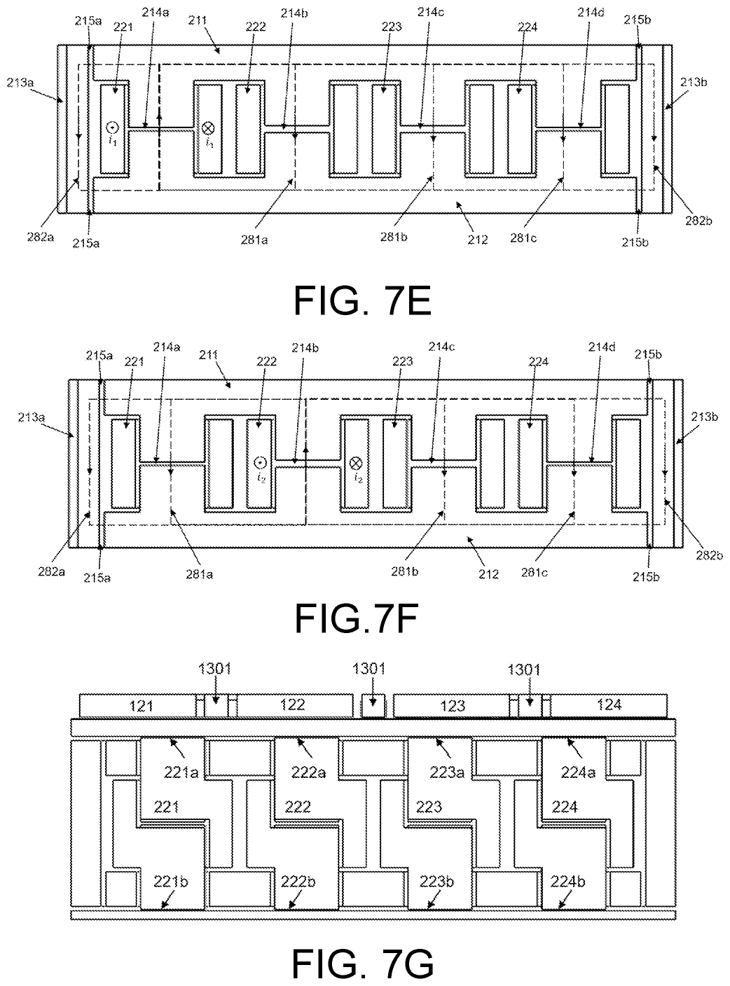

FIG. 7A is a schematic structural diagram of a four-phase VRM in this embodiment, FIG. 7B is an exploded view of the integrated coupled inductor 200, and FIG. 7C is a schematic structural diagram of the coupled inductor 210; and FIG. 7E and FIG. 7F are cross-sectional views of the section A-A in FIG. 7C. The difference between the embodiment and the embodiment 4, and, the difference between the Embodiment 2 and the Embodiment 1 are the same, that is, the integrated coupled inductor 200 and the coupled inductor 210 are different, but the technical effect generated by the integrated coupled inductor 200 is the same as that of Embodiment 2, and the arrangement mode of the air gap in this embodiment is the same as that of the Embodiment 4.

FIG. 7G is a front view of FIG. 6A, as shown in FIG. 7G, first bonding pads 221a, first bonding pads 222a, first bonding pads 223a and first bonding pads 224a of the first winding 221, the second winding 222, the third winding 223 and the fourth winding 224 are respectively vertically connected with the IPM unit 121, the IPM unit 122, the IPM unit 123 and the IPM unit 124; but the input capacitor 1301 is arranged between the IPM unit 121, the IPM unit 122, the IPM unit 123 and the IPM unit 124 at intervals, so that the first bonding pad of the winding is directly and vertically connected with the SW Pad of the IPM unit, no transverse current exists between the first bonding pad of the winding and the SW Pad of the IPM unit, and the VRM is high in efficiency.

### Embodiment 6

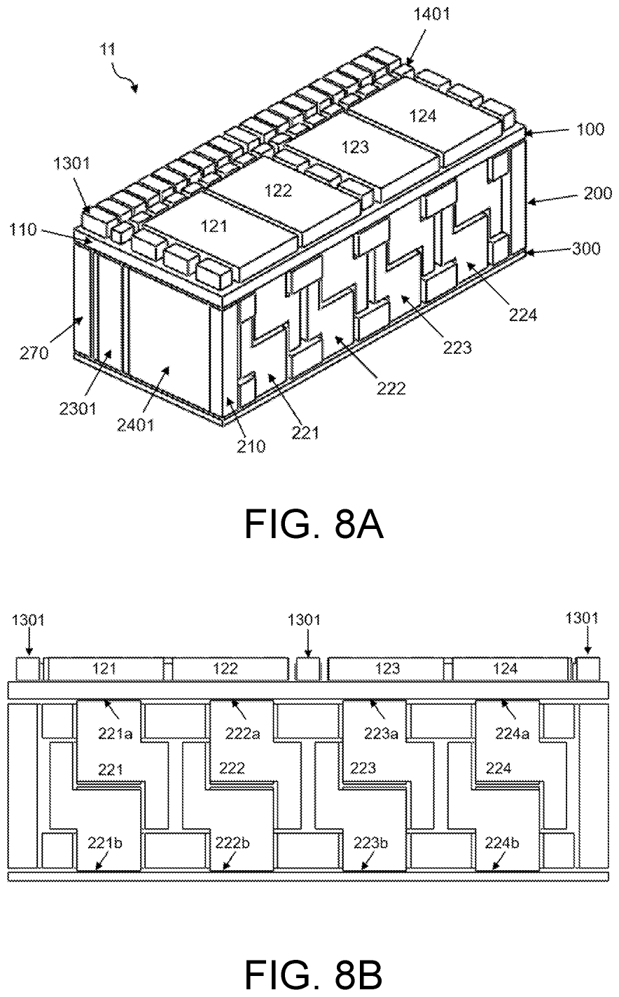

FIG. 8A is a schematic structural diagram of a four-phase VRM in this embodiment, and FIG. 8B is a front view. According to this embodiment, the position of the input capacitor 1301 is adjusted on the basis of the Embodiment 4. As shown in FIG. 8A and FIG. 8B, an input capacitor 1301 is not provided between the IPM unit 121 and the IPM unit 122, an input capacitor 1301 is not provided between the IPM unit 123 and the IPM unit 124, but the input capacitor 1301 is provided between every two phases and the edge of the module. In this way, on the premise that the filtering effect of the input capacitor is not affected, the alignment area of the first bonding pad of the winding and the SW pad of the IPM unit is maximized; the welding area of the winding and the SW pad is increased, the impedance between the winding bonding pad and the IPM unit SW is reduced, and the efficiency is improved.

The invention has the following beneficial effects:
(1) the ferrite material with high permeability is used for a main magnetic flux path, so that the coupled inductor has good coupled characteristics, the high coupled coefficient allows to achieve a large steady state inductance, to reduce ripple current of the inductance, and to reduce AC loss of the switching device; the ferrite material with a low core loss density is favor to reduce the loss of coupled inductance core;
(2) The low-permeability powder core material is used for a flux leakage path, so that the leakage inductance saturation characteristic is good, and the leakage inductance has relatively high saturation current; thus, leakage inductance is still maintained at a certain inductance under large transient load current changes, which can protect the switching device from large current stresses; under the change of the large transient load current, the leakage inductance still maintains a certain inductance, and the switching device can be protected from large current stress;
(3) Through symmetrical arrangement of unbalanced air gaps on different phase magnetic columns in the coupled inductor, coupled balance among multiple phases can be realized, coupled equalization is beneficial to reduction of output ripple current, the leakage inductance can be further reduced under the condition that the steady-state inductance is the same, and the dynamic performance of the multi-phase VRM is further improved;
(4) One end of the windings is connected to the switching device, and the anther end of the windings is directly connected with the load, so that the current of the power part does not flow transversely, the loss caused by transverse flowing of the power current is eliminated, and the efficiency of the VRM is improved.

What is claimed is:

1. An apparatus, comprising:
an inductor assembly and a connector;
wherein the inductor assembly comprises a magnetically permeable core and at least two windings;
wherein the magnetically permeable core comprises a first magnetically permeable core and a second magnetically permeable core;
wherein the first magnetically permeable core comprises at least two magnetic columns and at least two cover plates, and the at least two magnetic columns are arranged between the at least two cover plates;
wherein the first magnetically permeable core is made of a first magnetic material;
wherein the second magnetically permeable core is arranged between two adjacent magnetic columns or on the side surface of the first magnetically permeable core;
wherein the second magnetically permeable core is made of a second magnetic material;
wherein the permeability of the second magnetic material is lower than that of the first magnetic material;
wherein each winding is wound on at least one magnetic column corresponding to the winding;
wherein the winding comprises a first bonding pad and a second bonding pad, the first bonding pad is arranged on the top surface of the inductor assembly, and the second bonding pad is arranged on the bottom surface of the inductor assembly;
wherein the connector comprises a power connector and a signal connector; the power connector and the signal connector are arranged on the outer side surface of the inductor assembly respectively;
wherein the power connector is used for transmitting power current between the top surface and the bottom surface of the inductor assembly; the power connector comprises a power Vin and a power GND;
wherein the signal connector is used for transmitting a signal current between the top surface and the bottom surface of the inductor assembly.

2. The apparatus of claim 1, wherein in a working process of the apparatus, magnetic fluxes generated by the current in the windings are mutually counteracted in the first magnetically permeable core; and the magnetic fluxes generated by the current in the windings are mutually enhanced in the second magnetically permeable core.

3. The apparatus of claim 1, wherein a relative permeability of the first magnetic material is higher than 200; and a relative permeability of the second magnetic material is lower than 200.

4. The apparatus of claim 1, wherein at least two pairs of power Vin and power GND are provided, each pair of power Vin and power GND are respectively arranged side by side on one side surface of the magnetically permeable core, and the signal connector is arranged on one side surface of the magnetically permeable core which is not provided with the power Vin and the power GND; a metal shielding layer is arranged between the connector and the magnetically permeable core, and the connector and the metal shielding layer are electrically isolated.

5. The apparatus of claim 4, wherein the connector and the second magnetically permeable core are integrally pressed and formed.

6. The apparatus of claim 4, wherein the connector and the shielding layer are both arranged on at least one PCB assembly, and the at least one PCB assembly and the inductor assembly form the apparatus through assembly.

7. The apparatus of claim 1, wherein the number of the windings is N, and N is greater than 2; the number of the magnetic columns is N, and the magnetic columns are in one-to-one correspondence with the windings;
wherein the second magnetically permeable core is arranged between two adjacent magnetic columns,
wherein the second magnetically permeable core is N−1, and the magnetic column and the second magnetically permeable core are alternately arranged.

8. The apparatus of claim 7, wherein a first air gap is formed in the magnetic column, and a second air gap is formed in the second magnetically permeable core; the first air gap is arranged in a symmetrical and unbalanced mode, and/or the second air gap is arranged in a symmetrical and unbalanced mode; the magnetic column and/or the second magnetically permeable core are arranged from one side surface of the inductor assembly to another side surface in a symmetrical mode, and the first air gap and/or the second air gap are sequentially increased from the edge to the center of the inductor assembly; and the first air gap and/or the second air gap which are symmetrical in center are equal in size.

9. The apparatus of claim 1, wherein the at least two windings are wound on the same magnetic column of the first magnetically permeable core; the second magnetically permeable core is annular or arc-shaped, and the second magnetically permeable core surrounds the at least one magnetic column and is arranged between the at least two windings.

10. A voltage regulator module comprising:
at least one apparatus of claim 1, both the first pad and the second pad being adjacent to a first side surface of the inductor assembly;
wherein a top plate comprises an IPM unit and a passive element;
wherein a side conductive connector comprises a signal conductive connector and a power conductive connector, and the side conductive connector is arranged on another side surface, different from the first side surface, of the voltage regulator module;
wherein the IPM unit is electrically connected with a first bonding pad of a corresponding winding, and the second bonding pad is used for being electrically connected with a load.

11. The voltage regulator module of claim 10, wherein the IPM unit is arranged at the position, close to the first side surface, of the top plate, and the IPM unit is arranged in a mode perpendicular to the winding.

12. The voltage regulator module of claim 10, wherein the passive element comprises an input capacitor, at least two IPM units are provided, and at least a part of the input capacitor is arranged between two adjacent IPM units.

13. The voltage regulator module of claim 10, wherein the passive element comprises an input capacitor, the number of the IPM units is more than two, and at least a part of the input capacitor is arranged between every two adjacent IPM units.

14. The voltage regulator module of claim 10, wherein in a working process of the voltage regulator module, the magnetic fluxes generated by the current in the windings are mutually counteracted in the first magnetically permeable core; and the magnetic fluxes generated by the current in the windings are mutually enhanced in the second magnetically permeable core.

15. The voltage regulator module of claim 10, wherein at least two pairs of power Vin and power GND are provided, each pair of power Vin and power GND are respectively arranged side by side on one side surface of the magnetically permeable core, and the signal connector is arranged on one side surface of the magnetically permeable core which is not provided with the power Vin and the power GND; a metal shielding layer is arranged between the connector and the magnetically permeable core, and the connector and the metal shielding layer are electrically isolated.

16. The voltage regulator module of claim 15, wherein the connector and the shielding layer are both arranged on at least one PCB assembly, and the at least one PCB assembly and the inductor assembly form the apparatus through assembly.

17. The voltage regulator module of claim 10, wherein the number of the windings is N, and N is greater than 2; the number of the magnetic columns is N, and the magnetic columns are in one-to-one correspondence with the windings;
wherein the second magnetically permeable core is arranged between two adjacent magnetic columns, specifically:
wherein the second magnetically permeable core is N−1, and the magnetic column and the second magnetically permeable core are alternately arranged.

18. The voltage regulator module of claim 10, wherein the at least two windings are wound on the same magnetic column of the first magnetically permeable core; the second magnetically permeable core is annular or arc-shaped, and the second magnetically permeable core surrounds the at least one magnetic column and is arranged between the at least two windings.

19. The voltage regulator module of claim 10, wherein the at least two windings are wound on the same magnetic column of the first magnetically permeable core; the second magnetically permeable core is annular or arc-shaped, and the second magnetically permeable core surrounds the at least one magnetic column and is arranged between the at least two windings.
